(19) United States
(12) Patent Application Publication
(10) Pub. No.: US 2018/0034350 A1
(43) Pub. Date: Feb. 1, 2018

(54) METHOD FOR COMPENSATING FOR THERMAL DISTORTION OF A PART

(71) Applicant: General Electric Company, Schenectady, NY (US)

(72) Inventor: Kudum Shinde, Bangalore (IN)

(21) Appl. No.: 15/225,110

(22) Filed: Aug. 1, 2016

(51) Int. Cl. H02K 15/02

(52) U.S. Cl. CPC H02K 15/02

(57) ABSTRACT

A method of manufacturing an annular case or part such that distortion due to operational conditions is reduced. The method of manufacturing includes the steps of: identifying a distortion-shape of the base configuration as it would occur by modeling operational conditions; identifying a counter-distortion-shape which is the geometric difference between a predetermined base pattern and the distortion-shape; designing a base-counter-distortion-shape such that the base-counter-distortion-shape includes pseudo-flanges; creating a modified-base-configuration by adding the pseudo-flanges to the base configuration design positioned in locations analogous to that in the base-counter-distortion-shape; and manufacturing the high pressure compressor aft-section according to the modified-base-configuration.

### BACKGROUND OF THE INVENTION

The present invention relates to the design of an aft extension case for an aircraft engine and more specifically to a method for reducing distortions created by the split flanges used to assemble the aft extension case.

The aft extension case of an aircraft engine is subject to thermal stresses and thrust-load stresses. More specifically, high pressure compressor (HPC) aft extension cases are subject to thrust link punch and horizontal split-line flanges thermal effects which cause distortion. This distortion affects HPC aft stages and beyond. One example of such an effect is that the aft extension case can be caused to be out of round. Because of potential out of roundness in the aft extension case, additional clearance must be left for the tips of blades positioned within the HPC aft extension case than otherwise would be required. It is believed that an engine is less efficient as a result of this additional clearance than the engine would be if the clearance were minimized.

### BRIEF DESCRIPTION OF THE INVENTION

This need is addressed by pseudo-flanges that are sized and positioned on an HPC aft extension case in accordance with a method of the present invention such that the pseudo-flanges are configured to cancel distortion.

According to one aspect of the technology described herein there is provided a method of manufacturing a part such that distortion due to operational conditions is reduced, the method of manufacturing comprising the steps of: determining a distortion-shape of an existing part during its operational use; identifying a counter-distortion-shape which is the geometric difference between a predetermined base pattern and the distortion-shape; designing a base-counter-distortion-shape such that the base-counter-distortion-shape includes additional hardware; and creating a modified-base-configuration by adding hardware to the part such that the hardware is positioned in locations analogous to that in the base-counter-distortion-shape.

According to another aspect of the technology described herein there is provided a method of manufacturing an annular case such that distortion due to operational conditions is reduced, the method of manufacturing comprising the steps of: identifying a distortion-shape of a base configuration of the annular case as it would occur by modeling operational conditions; identifying a counter-distortion-shape which is the geometric difference between a predetermined base pattern and the distortion-shape; designing a base-counter-distortion-shape such that the base-counter-distortion-shape includes pseudo-flanges; and creating a modified-base-configuration by adding the pseudo-flanges to the base configuration design positioned in locations analogous to that in the base-counter-distortion-shape.

### BRIEF DESCRIPTION OF THE DRAWINGS

The invention may be best understood by reference to the following description taken in conjunction with the accompanying drawing figures in which:

FIG. 1 shows a perspective view of the aft section of an aircraft engine compressor; and

FIG. 2 is a perspective view of the aft section of an aircraft engine compressor that includes pseudo-flanges.

### DETAILED DESCRIPTION OF THE INVENTION

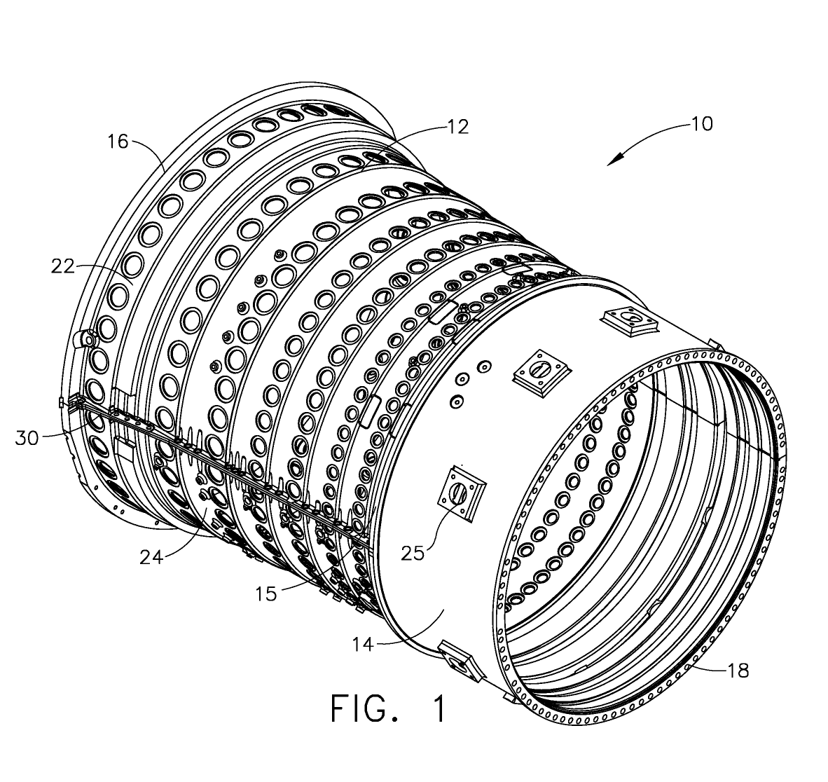

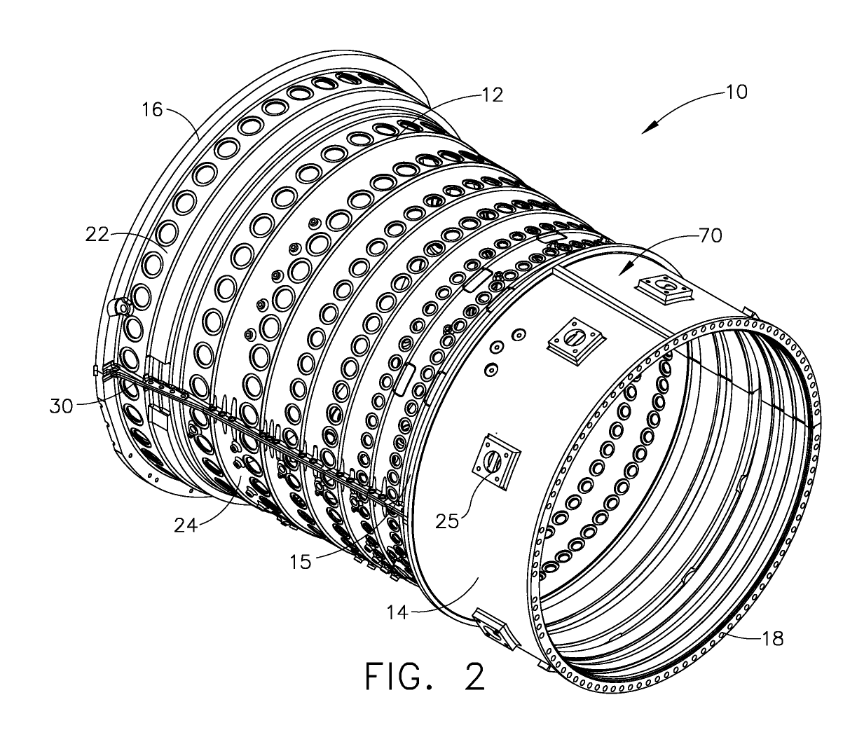

Referring to the drawings wherein identical reference numerals denote the same elements throughout the various views, FIG. 1 shows annular case or stator 10. As shown in FIG. 1, stator 10 is a high pressure compressor (“HPC”) aft section. The stator 10 is generally tubular and has a substantially circular cross-section. It should be appreciated that the diameter of stator 10 can vary along its length from a first end 16 to a second end 18. The stator 10 includes a first section 12 and a second section 14. The first section 12 is joined to the second section 14 at corresponding circumferential flanges 15. The first section 12 includes a first half 22 and a second half 24 which are joined at split flanges 30. Other surface features 25 can be positioned on stator 10. As shown in FIG. 2, the split flanges 30 are positioned at 0° and 180°. Two pseudo-flanges 70 are positioned at 90° and 270° respectively.

The method of the present invention can be better understood by a description of the application of the method to a stator 10. First, the hypothetical stator 10 is modeled under operational conditions. The distortion-shape of the base configuration is determined to be a first ellipse. Next, the counter-distortion-shape that correlates to the first ellipse is determined. The counter-distortion shape is the shape that when geometrically combined with the original distortion shape results in a predetermined shape that matches the design goal.

In the case of an ellipse, the counter-distortion-shape is an ellipse having the same center but having the major axis rotated 90° relative to the major axis of the first ellipse. Therefore the counter-distortion-shape of the first ellipse is a second ellipse having the same length major and minor axes as the first ellipse where the orientation of the major axis is rotated 90° relative to the first ellipse.

Determining the distortion shape of the base configuration can be achieved through modeling methods such as finite element-based modeling. Ideally, the design goal shape is such that a perfect circle would result at the interface between the stator and the rotor. A perfect circle at the interface between the stator in the rotor allows for minimum clearances throughout a revolution of the rotor. In other words, there are no close tolerance areas for which the rotor must be designed that would require rotor dimension smaller than would otherwise be required to provide clearance relative to other areas of the stator.

Once the counter distortion shape is determined, determining the pseudo-flange's angular placement θ is the next step. In the hypothetical stator 10, the distortion is caused by the split flanges. As indicated above, to cause the counter distortion such that it is rotated 90° relative to the distortion caused by the split flanges, a mass and geometric configuration of pseudo-flanges must be analogous to the split flanges but positioned about 90° therefrom. In this regard, if the split flanges are positioned at 0° and 180°, the pseudo-flanges would be positioned at 90° and 270°.

According to one aspect of the technology described herein there is provided a method that can include the following multiple steps: A) designing a base configuration; B) modeling a base configuration under operational conditions; C) identifying a distortion-shape of the base configuration as it would occur under operational conditions; D) identifying pinch points that would occur under operational conditions between the stator and the rotor; E) preparing a polar plot identifying the radial location of the pinch points; F) comparing the distortion-shape to a predetermined base pattern; G) quantifying the distortion-shape; H) identifying the counter-distortion-shape which is the geometric difference between the predetermined base pattern and the distortion-shape; I) designing a base-counter-distortion-shape such that the base-counter-distortion-shape includes pseudo-flanges; J) determining pseudo-flanges angular placement θ; K) creating a modified-base-configuration by adding the pseudo-flanges to the base configuration design positioned in locations analogous to that in the base-counter-distortion-shape; and L) manufacturing the high pressure compressor aft-section according to the modified-base-configuration.

It should be appreciated that the method presented above can be used to modify existing hardware such that that pinch points are reduced and a more uniform, nearly circular, clearance is created between existing parts. In this regard, steps A) through step C) would be replaced by a step of determining actual distortion of an existing part during its operational use. Additionally, steps K) and L) would be replaced by a step of modifying the existing hardware. Such modification of existing hardware could include the addition of a structure such as a bolt extending between two opposing flanges on an aft section of an HPC. A modification can also include hardware configured to provide localized cooling or heating of a particular area. Such localized cooling could be achieved by pinching the particular area with a gas.

The apparatus and method of the present invention provides pseudo-flanges that are configured to act to reduce 3-D distortion in high pressure compressors. The commercial advantage of the present invention is realized in the design methods for reducing 3-D distortion in HPC. By reducing the 3-D distortion in HPC, the out-of-roundness of the case is reduced. The resulting reduction in out-of-roundness improves blade tip clearances thereby improving engine efficiency.

The foregoing has described an apparatus and a method for reducing the out of roundness of HPC aft extension cases by providing pseudo-flanges positioned according to the method described above and all of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying potential points of novelty, abstract and drawings), or to any novel one, or any novel combination, of the steps of any method or process so disclosed.

What is claimed is:

1. A method of manufacturing a part such that distortion due to operational conditions is reduced, the method of manufacturing comprising the steps of:
determining a distortion-shape of an existing part during its operational use;
identifying a counter-distortion-shape which is the geometric difference between a predetermined base pattern and the distortion-shape;
designing a base-counter-distortion-shape such that the base-counter-distortion-shape includes additional hardware; and
creating a modified-base-configuration by adding hardware to the part such that the hardware is positioned in locations analogous to that in the base-counter-distortion-shape.

2. The method according to claim 1, further comprising the step of: modeling a base configuration as it would occur under operational conditions.

3. The method according to claim 2, further comprising the step of: quantifying the distortion-shape.

4. The method according to claim 3, further comprising the step of: designing a base configuration.

5. The method according to claim 4, further comprising the step of: identifying pinch points that occur under operational conditions near the part;

6. The method according to claim 5, further comprising the step of: preparing a polar plot identifying the radial location of the pinch points.

7. The method according to claim 1 wherein the part is the aft section of a high pressure compressor.

8. The method according to claim 1 wherein the hardware is configured to provide gas impingement to affect the temperature in a predetermined locality.

9. The method according to claim 1 wherein the part includes two spaced-apart circumferential flanges and the hardware is configured to affect a mechanical link between the two circumferential flanges.

10. The method according to claim 1 wherein the part is an annular case.

11. The method according to claim 1 wherein the part is a compressor aft section.

12. A method of manufacturing an annular case such that distortion due to operational conditions is reduced, the method of manufacturing comprising the steps of:
identifying a distortion-shape of a base configuration of the annular case as it would occur by modeling operational conditions;
identifying a counter-distortion-shape which is the geometric difference between a predetermined base pattern and the distortion-shape;
designing a base-counter-distortion-shape such that the base-counter-distortion-shape includes pseudo-flanges; and
creating a modified-base-configuration by adding the pseudo-flanges to the base configuration design positioned in locations analogous to that in the base-counter-distortion-shape.

13. The method according to claim 12, further comprising the step of: manufacturing the annular case according to the modified-base-configuration.

14. The method according to claim 13, further comprising the step of: modeling a base configuration as it would occur under operational conditions.

15. The method according to claim 14, further comprising the step of: quantifying the distortion-shape.

16. The method according to claim 15, further comprising the step of: designing a base configuration.

17. The method according to claim 16, further comprising the step of: identifying pinch points that occur under operational conditions between the stator and the rotor;

18. The method according to claim 17, further comprising the step of: preparing a polar plot identifying the radial location of the pinch points.

19. A method of manufacturing a stator according to claim 11 wherein the stator is the aft section of a high pressure compressor.
